(19) United States
(12) Patent Application Publication
(10) Pub. No.: US 2025/0077184 A1
(43) Pub. Date: Mar. 6, 2025

(54) SYSTEM FOR PREDICTING A PSEUDO-RANDOM INITIAL SEED

(71) Applicants: KONGJU NATIONAL UNIVERSITY INDUSTRY-UNIVERSITY COOPERATION FOUNDATION, Gongju-si (KR); Daegu Gyeongbuk Institute of Science and Technology, Daegu (KR)

(72) Inventors: Woosang Im, Sejong-si (KR); Inkyu Moon, Daegu (KR); Ongee Jeong, Daegu (KR)

(21) Appl. No.: 18/510,839

(22) Filed: Nov. 16, 2023

(30) Foreign Application Priority Data
Aug. 30, 2023 (KR) 10-2023-0114208

(51) Int. Cl. G06F 7/58

(52) U.S. Cl. CPC G06F 7/582

(57) ABSTRACT

The present invention relates to a system for predicting a pseudo-random number initial seed, and more particularly, to a system for predicting a pseudo-random number initial seed to receive N sequence vectors for a pseudo-random number to extract a learning vector containing feature information for each of the N sequence vectors, and receive the learning vector to derive initial seed information for the pseudo-random number.

### BACKGROUND OF THE INVENTION

### 1. Field of the Invention

The present invention relates to a system for predicting a pseudo-random number initial seed, and more particularly, to a system for predicting a pseudo-random number initial seed to receive N sequence vectors for a pseudo-random number to extract a learning vector containing feature information for each of the N sequence vectors, and receive the learning vector to derive initial seed information for the pseudo-random number.

### 2. Description of the Related Art

Large amounts of data has been generated and used in various industries as science technology develops, however, concerns about data security are increasing due to frequent data leaks. Accordingly, encryption technology has been introduced to transform original data into an unrecognizable form so as to protect personal information contained in the data. Since a secret key used in the encryption process uses random numbers that cannot be easily predicted by an attacker, it is very important to generate the random numbers.

A pseudo-random number refers to a number generated by an algorithm (pseudo-random number generator) that has already been determined using an initially given initial value. In other words, there is no fixed method for generating a random number and a value generated next to the random number cannot be predicted at all, whereas the pseudo-random number is generated by the pseudo-random number generator, and accordingly the pseudo-random number is called differently from the random number since the prediction is possible when an initial value or algorithm (sequence) of the pseudo-random number generator is known.

A machine learning-based method or a simple deep learning model may be used to predict the pseudo-random number sequence or initial value, but does not utilize the feature in which the pseudo-random number generator generates a pseudo-random number sequence having periodicity, and accordingly, there are problems in the aspect of accuracy and the like.

Thus, there is a need for the invention that recognizes a pseudo-random number sequence as time-series data, and establishes a recurrent neural network optimized for predicting the time series data, thereby deriving the initial value or sequence when information on a pseudo-random number is input.

### SUMMARY OF THE INVENTION

The present invention relates to a system for predicting a pseudo-random number initial seed, and more particularly, to a system for predicting a pseudo-random number initial seed to receive N sequence vectors for a pseudo-random number to extract a learning vector containing feature information for each of the N sequence vectors, and receive the learning vector to derive initial seed information for the pseudo-random number.

In order to solve the above conventional problems, one embodiment of the present invention provides as a pseudo-random number prediction system for predicting a pseudo-random initial seed, which includes: a feature extraction module for receiving N sequence vectors (N is a natural number of 1 or more) for a pseudo-random number to extract a learning vector for each of the N sequence vectors containing feature information on the pseudo-random number; and a prediction module for receiving the learning vector for each of the N sequence vectors extracted from the feature extraction module to derive initial seed information on the pseudo-random number.

According to one embodiment of the present invention, the feature extraction module may include a first feature extraction unit and a second feature extraction unit, in which the first feature extraction unit may receive the N sequence vectors to extract a first learning vector containing first feature information for each of the N sequence vectors, and the second feature extraction unit may receive the first learning vector for each of the N sequence vectors extracted from the first feature extraction unit to extract a second learning vector containing second feature information for each of the N sequence vectors.

According to one embodiment of the present invention, the first feature extraction unit may use the learned bidirectional long short-term memory (BLSTM) to extract a forward feature and a reverse feature for the N sequence vectors, and input the forward feature and the reverse feature into an activation function, thereby extracting a first learning vector containing first feature information for each of the N sequence vectors, and the second feature extraction unit may use the learned LSTM to extract a second learning vector containing the second feature information for each of the N sequence vectors.

According to one embodiment of the present invention, some preset number of learned nodes included in the learned BLSTM may be removed to prevent overfitting, some preset number of learned nodes included in the learned LSTM may be removed to prevent overfitting, the BLSTM may include a forward part including at least one LSTM; and a reverse part including at least one LSTM, and the N sequence vectors are input to the forward part and the reverse part, so as to be input in a forward direction according to a sequence of pseudo-random numbers to the at least one LSTM included in the forward part, and input in a reverse direction of the forward direction input to the forward part to the at least one LSTM included in the reverse part.

According to one embodiment of the present invention, since the pseudo-random number generator operates based on a pseudo-random number sequence having periodicity, a pseudo-random number is recognized as time series data and a vector for the pseudo-random number is input into a recurrent neural network optimized for time series data prediction, so that initial seed information on the pseudo-random number can be more effectively extracted.

According to one embodiment of the present invention, the first feature extraction unit includes BLSTM to extract the first learning vector containing the first feature information, so as to derive a forward feature from the first portion to the last portion of a time series array for N or more sequence vectors, and derive a reverse feature from the last portion to the first portion of the time series array for the N or more sequence vectors, so that sufficient features for time series data can be derived.

According to one embodiment of the present invention, some of the learned nodes of BLSTM for the first feature extraction unit and LSTM for the second feature extraction unit are deleted, so that overfitting to data output values can be prevented.

According to one embodiment of the present invention, the first feature extraction unit is composed of the BLSTM model other than the GRU model, so that the initial seed information can be predicted with higher accuracy compared to being composed of the GRU.

### BRIEF DESCRIPTION OF THE DRAWINGS

FIG. 1 shows a pseudo-random number prediction system for predicting a pseudo-random initial seed according to one embodiment of the present invention.

FIG. 2 shows a feature extraction module according to one embodiment of the present invention.

FIG. 3 shows a prediction module according to one embodiment of the present invention.

FIG. 4 shows an internal configuration of the pseudo-random number prediction system according to one embodiment of the present invention.

FIGS. 5A and 5B show LSTM according to one embodiment of the present invention.

FIGS. 6A and 6B show learning graphs for prediction models according to one embodiment of the present invention.

FIGS. 7A and 7B show learning graphs for prediction models according to one embodiment of the present invention.

FIG. 8 schematically shows internal components of the computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

The present invention relates to technology for predicting a pseudo-random number sequence and an initial seeds generated through a pseudo-random number generator using a neural network model. When the feature, in which the pseudo-random number generator generates a pseudo-random number sequence having periodicity, is applied to recognize a pseudo-random number sequence as time-series data, and use a recurrent neural network (RNN) optimized for predicting the time series data, so that a pseudo-random number sequence can be effectively predicted.

The neural network model includes the recurrent neural network (RNN) may include BLSTM and LSTM. In other words, a sequence and an initial seed for a pseudo-random number may be predicted using the BLSTM and the LSTM. The pseudo-random number sequence may refer to an algorithm of a pseudo-random number generator.

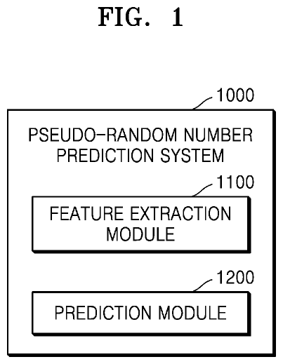

FIG. 1 shows a pseudo-random number prediction system 1000 for predicting a pseudo-random initial seed according to one embodiment of the present invention.

As shown in FIG. 1, the pseudo-random number prediction system 1000 for predicting a pseudo-random initial seed includes: a feature extraction module 1100 for receiving N sequence vectors (N is a natural number of 1 or more) for a pseudo-random number to extract a learning vector for each of the N sequence vectors containing feature information on the pseudo-random number; and a prediction module 1200 for receiving the learning vector for each of the N sequence vectors extracted from the feature extraction module 1100 to derive initial seed information on the pseudo-random number.

The pseudo-random number prediction system 1000, may include a feature extraction module 1100 and a prediction module 1200 as neural network models. The feature extraction module 1100 and the prediction module 1200 may be formed of a plurality of recurrent neural networks.

Specifically, the feature extraction module 1100 may receive a sequence vector for a pseudo-random number sequence to obtain a hidden state value corresponding to each of a plurality of neural network cells, and may output a learning vector for extracted feature information (value). The feature extraction module 1100 may include BLSTM and LSTM.

The BLSTM and the LSTM may include a neural network trained to extract the feature information.

In all feature information extraction processes, a plurality of hidden state values corresponding to each neural network cell included in each module may be obtained upon each round so as to be continuously used for the next round of learning.

The prediction module 1200 may receive a learning vector to obtain a weight vector for each of the neural network cells included in the prediction module 1200, and output initial seed information, which is a label value, based on the learning vector. The prediction module 1200 may be composed of a full connection layer 1210 and a regression layer 1220.

The feature extraction module 1100 and the prediction module 1200 will be described later in detail.

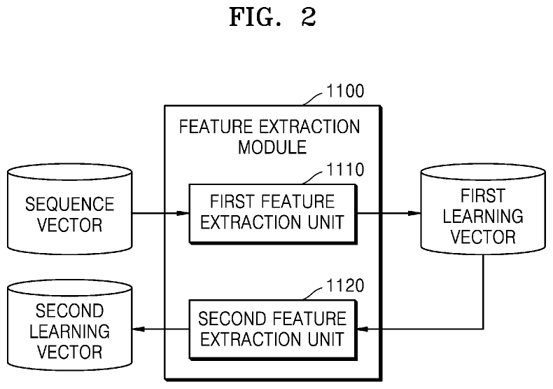

FIG. 2 shows the feature extraction module 1100 according to one embodiment of the present invention.

As shown in FIG. 2, the feature extraction module 1100 may include a first feature extraction unit 1110 and a second feature extraction unit 1120, in which the first feature extraction unit 1110 may receive the N sequence vectors to extract a first learning vector containing first feature information for each of the N sequence vectors, and the second feature extraction unit 1120 may receive the first learning vector for each of the N sequence vectors extracted from the first feature extraction unit 1110 to extract a second learning vector containing second feature information for each of the N sequence vectors.

The feature extraction module 1100 may include a first feature extraction unit 1110 and a second feature extraction unit 1120, so that the second learning vector may be output from the input sequence vector.

Specifically, a sequence vector may be input to the first feature extraction unit 1110, and the first feature extraction unit 1110 may output a first learning vector containing feature information of the sequence vector based on the sequence vector.

the first feature extraction unit 1110 may include N or more LSTMs (N is a natural number) as a BLSTM, and the sequence vector may be sequentially input to each of the N or more LSTMs according to a sequence of a corresponding pseudo-random number. Details thereof will be described later.

The second feature extraction unit 1120 may include N or more LSTMs (N is a natural number) as LSTM, and the N or more first learning vectors output from the first feature extraction unit 1110 may be sequentially input to each of the N or more LSTMs (N is a natural number) of the second feature extraction unit 1120. Details thereof will be described later.

The second feature extraction unit 1120 may receive the first learning vector and output the second learning vector, and the second learning vector may include feature information on a pseudo-random number.

Details, which is not described about the LSTM and the BLSTM, may be subject to the commonly known or used art.

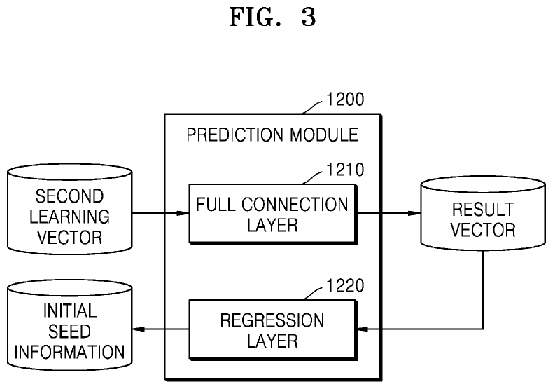

FIG. 3 shows the prediction module 1200 according to one embodiment of the present invention.

As shown in FIG. 3, the prediction module 1200 may include a full connection layer 1210 and a regression layer 1220, in which the full connection layer 1210 may receive a learning vector for each of the N sequence vectors from the feature extraction module 1100 and output a result vector for each of the N sequence vectors, and the regression layer 1220 may receive the result vector for each of the N sequence vectors from the full connection layer 1210 and output initial seed information on the corresponding pseudo-random number.

The prediction module 1200 may include the full connection layer 1210 and the regression layer 1220 so as to output the initial seed information from the input learning vector, preferably the second learning vector.

Specifically, the second learning vector may be input to the full connection layer 1210, and the full connection layer 1210 may output a result vector for a pseudo-random number, based on the second learning vector. In other words, the full connection layer 1210 may output result vectors for the N second learning vectors, respectively.

According to one embodiment of the present invention, the result vector may include feature information formed by combining feature information included in the first learning vector and feature information included in the second learning vector.

The result vector may be input to the regression layer 1220, and the regression layer 1220 may output initial seed information for a pseudo-random number, based on the result vector. In other words, the N result vectors output from the full connection layer 1210 may be input to the regression layer 1220 to output initial seed information.

The initial seed information may include initial seed for a corresponding pseudo-random number.

According to another embodiment of the present invention, the result vector may be input to the regression layer 1220, and the regression layer 1220 may output a next pseudo-random number of the input sequence vector for the pseudo-random number, based on the result vector.

Details, which is not described about the full connection layer 1210 and the regression layer 1220, may be subject to the commonly known or used art.

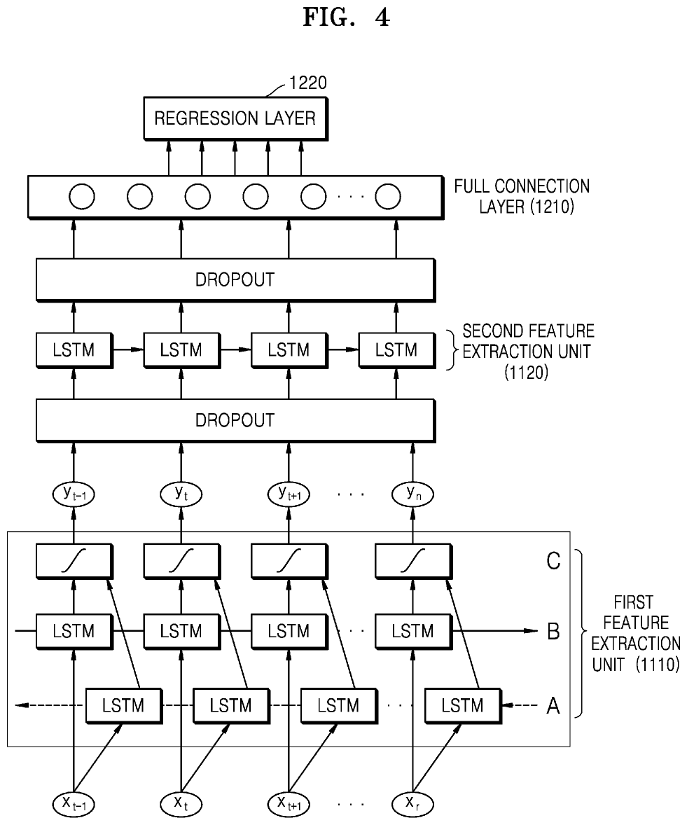

FIG. 4 shows an internal configuration of the pseudo-random number prediction system 1000 according to one embodiment of the present invention.

As shown in FIG. 4, the first feature extraction unit 1110 may use the learned bidirectional long short-term memory (BLSTM) to extract a forward feature and a reverse feature for the N sequence vectors, and input the forward feature and the reverse feature into an activation function, thereby extracting a first learning vector containing first feature information for each of the N sequence vectors, and the second feature extraction unit 1120 may use the learned LSTM to extract a second learning vector containing the second feature information for each of the N sequence vectors. Some preset number of learned nodes included in the BLSTM may be removed to prevent overfitting, a preset number of learned nodes included in the LSTM may be removed to prevent overfitting, the BLSTM includes a forward part B including at least one LSTM; and a reverse part A including at least one LSTM, and the N sequence vectors are input to the forward part B and the reverse part A so as to be input in a forward direction according to a sequence of pseudo-random numbers to the at least one LSTM included in the forward part B, and input in a reverse direction of the forward direction input to the forward part B to the at least one LSTM included in the reverse part A.

The first feature extraction unit 1110 may correspond to the learned BLSTM, and may include a forward part B, a reverse part A and an activation function part. The forward part B and the reverse part A may include at least one LSTM, and the activation function part may include at least one activation layer C.

One sequence vector (shown as Xₜ in FIG. 4) may be input to each of the at least one LSTM included in the forward part B, and the sequence vectors may be input to the LSTM sequentially (in the forward direction) according to the sequence of the corresponding pseudo-random numbers. A forward feature may be derived from the sequence vectors in the forward part B.

One sequence vector may be input to each of at least one LSTM included in the reverse part A, and the sequence vectors may be input to the LSTM in a reverse order (in the reverse direction) according to the sequence of the corresponding pseudo-random numbers. A reverse feature may be derived from the sequence vectors in the reverse part A.

According to one embodiment of the present invention, the forward LSTM and the reverse LSTM have the same physical structure, but the sequences for the input vectors may be opposite to each other.

The forward feature derived from the forward part B and the reverse feature derived from the reverse part A may be input to the activation layer C, and the activation layer C may output a first learning vector (shown as Yₜ in FIG. 4) containing first feature information formed by combining the forward feature and the reverse feature. The first learning vector may be derived for each sequence vector.

The second feature extraction unit 1120 may include at least one LSTM. A first learning vector may be input to each LSTM, and a second learning vector containing second feature information may be extracted from the second feature extraction unit 1120. The second learning vector may be derived for each sequence vector. According to one embodiment of the present invention, the first learning vector may be sequentially input to at least one LSTM according to the sequence of the sequence vector serving as a basis of the first learning vector.

The full connection layer 1210 may receive the second learning vector and output a result vector. The number of nodes of the full connection layer 1210 may be configured according to a length of the second learning vector.

The regression layer 1220 may receive the result vector to output initial seed information. According to another embodiment of the present invention, the regression layer 1220 may receive the result vector to output a next pseudo-random number information. The next pseudo-random number information may correspond to a next pseudo-random number of the corresponding pseudo-random number for the input sequence vector.

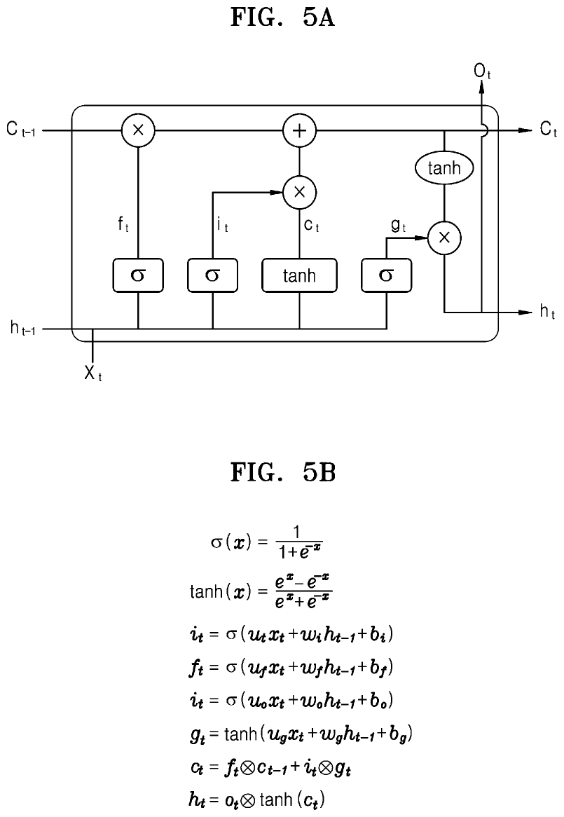

According to the present invention, some number of learned nodes for the learned BLSTM included in the first feature extraction unit 1110 serving as a recurrent neural network, and the LSTM included in the second feature extraction unit 1120 may be removed. Accordingly, overfitting can be prevented. In other words, results biased by learning data may be generalized, so that performance can be improved. FIGS. 5A and 5B show LSTM according to one embodiment of the present invention.

As shown in FIGS. 5A and 5B show, LSTM may include a sigmoid function and a hyperbolic tangent function.

FIG. 5A corresponds to a diagram showing a cell unit of LSTM.

FIG. 5B corresponds to a diagram showing mathematical equations for the cell unit of LSTM.

A cell unit of LSTM for the BLSTM and LSTM included in the first feature extraction unit 1110 and the second feature extraction unit 1120 may include a sigmoid function σ and a hyperbolic tangent function tanh. Input values input to the sigmoid function and the hyperbolic tangent function may be calculated according to multiplication or/and addition.

In the equations of FIG. 5B, u may correspond to a weight vector for a t^{th} input value Xₜ, w may correspond to a (t−1)^{th} hidden state value, and b may correspond to a bias for learning.

Details which is not described will be subject to the commonly known or used art.

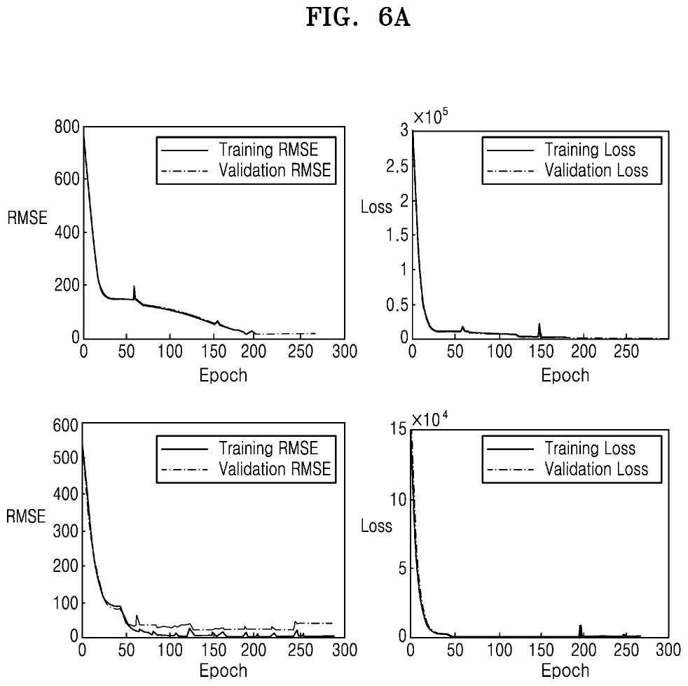

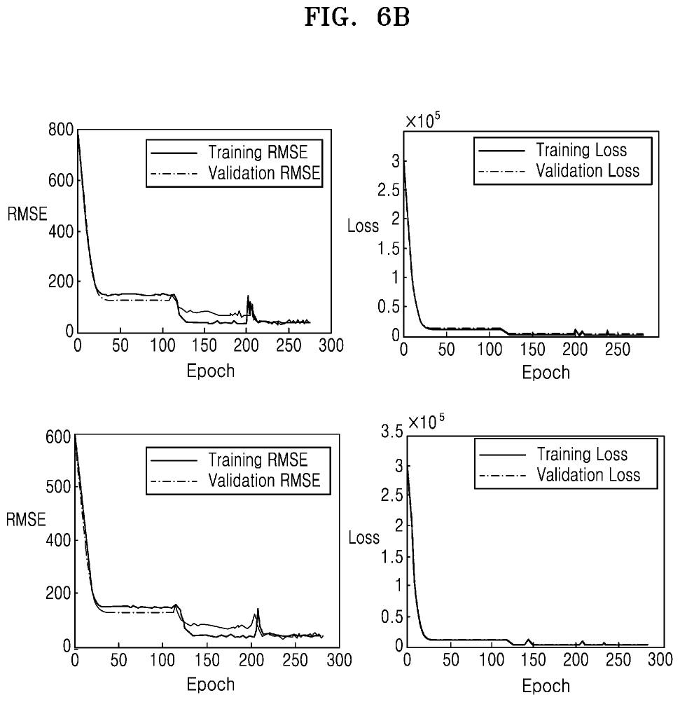

FIGS. 6A and 6B learning graphs for prediction models according to one embodiment of the present invention.

FIG. 6A shows learning graphs for a BLSTM-based prediction model.

FIG. 6B shows learning graphs for a GRU-based prediction model.

FIGS. 6A and 6B shows test results for proving prediction performance of each neural network model according to the present invention. In order to evaluate the performance, a root mean square error (RMSE) is used for the tests. The root mean square error loss function is defined as follows.

$$RMSE = \sqrt{\frac{1}{\text{?}} \text{?}}$$

$$\text{?} \text{indicates text missing or illegible when filed}$$

The loss function refers to a function for estimating a value so that the neural network model returns close to a correct answer by calculating an error between an actual label and a result value predicted by the neural network model. In this case, x may denote the actual correct answer value, and \hat{x} may denote the value predicted by the neural network model.

In addition, the data set uses a pseudo-random number sequence by using decimal numbers from 10 to 1000 as an initial seed. The first and last bits are used as tabs, so that a corresponding pseudo-random number sequence is generated by XOR operation.

Prediction is performed by dividing the sequence into short sequence data and long sequence data according to a length of the sequence, in which a data set of 492 length and a data set of 991 length are, respectively. The above-described two data sets are equivalently separated into training data, validation data, and test data separated at the ratio of 8:1:1 and used.

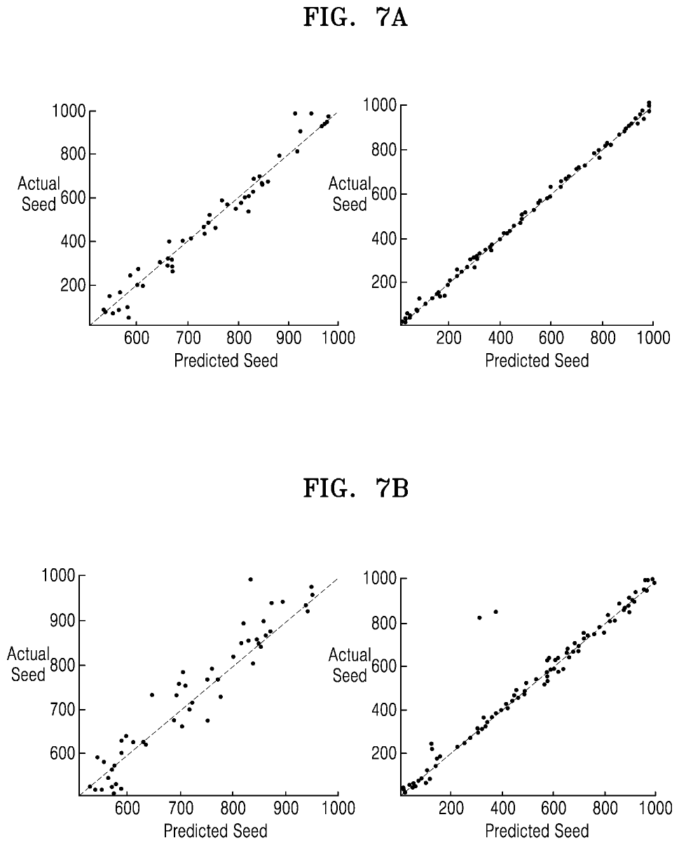

FIGS. 7A and 7B show learning graphs for prediction models according to one embodiment of the present invention.

FIG. 7A corresponds to diagrams showing initial seed prediction results for the BLSTM-based prediction model.

FIG. 7B corresponds to diagrams showing initial seed prediction results for the GRU-based prediction model.

The test results in FIGS. 7A and 7B analyze initial seed prediction performance of each neural network model on the generated test data. It is confirmed that the neural network model according to the present invention analyzes the initial seed almost perfectly for pseudo-random number sequences having various lengths.

Particularly, it can be seen that an initial seed value is better predicted for a long pseudo-random number sequence. In addition, since it can be seen that predictions are more precise when using the BLSTM model compared to the GRU model, the neural network model of the present invention may include BLSTM. The pseudo-random number prediction system 1000 of the present invention can be useful for various services since an initial seed can be effectively predicted for a pseudo-random number sequence.

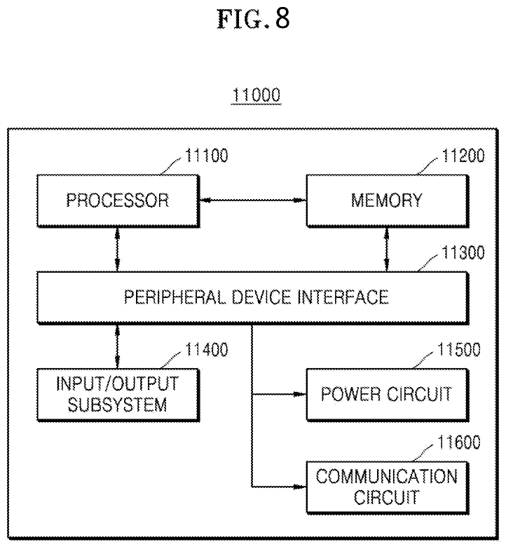

FIG. 8 schematically shows internal components of the computing device according to one embodiment of the present invention.

A pseudo-random number prediction system 1000 shown in the above-described FIG. 1 may include components of the computing device 11000 shown in FIG. 8.

As shown in FIG. 8, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to a pseudo-random number prediction system 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 8 is merely an example of the computing device 11000, and the computing device 11000 may have a configuration or arrangement in which some components shown in FIG. 8 are omitted, additional components not shown in FIG. 8 are further provided, or at least two components are combined. For example, a computing device for a communication terminal in a mobile environment may further include a touch screen, a sensor or the like in addition to the components shown in FIG. 8, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vice versa.

According to one embodiment of the present invention, the feature extraction module may include a first feature extraction unit and a second feature extraction unit, in which the first feature extraction unit may receive the N sequence vectors to extract first a learning g vector containing first feature information for each of the N sequence vectors, and the second feature extraction unit may receive the first learning vector for each of the N sequence vectors extracted from the first feature extraction unit to extract a second learning vector containing second feature information for each of the N sequence vectors.

According to one embodiment of the present invention, the first feature extraction unit may use the learned bidirectional long short-term memory (BLSTM) to extract a forward feature and a reverse feature for the N sequence vectors, and input the forward feature and the reverse feature into an activation function, thereby extracting a first learning vector containing first feature information for each of the N sequence vectors, and the second feature extraction unit may use the learned LSTM to extract a second learning vector containing the second feature information for each of the N sequence vectors.

According to one embodiment of the present invention, some preset number of learned nodes included in the learned BLSTM may be removed to prevent overfitting, some preset number of learned nodes included in the learned LSTM may be removed to prevent overfitting, the BLSTM may include a forward part including at least one LSTM; and a reverse part including at least one LSTM, and the N sequence vectors are input to the forward part and the reverse part, so as to be input in a forward direction according to a sequence of pseudo-random numbers to the at least one LSTM included in the forward part, and input in a reverse direction of the forward direction input to the forward part to the at least one LSTM included in the reverse part.

According to one embodiment of the present invention, since the pseudo-random number generator operates based on a pseudo-random number sequence having periodicity, a pseudo-random number is recognized as time series data and a vector for the pseudo-random number is input into a recurrent neural network optimized for time series data prediction, so that initial seed information on the pseudo-random number can be more effectively extracted.

According to one embodiment of the present invention, the first feature extraction unit includes BLSTM to extract the first learning vector containing the first feature information, so as to derive a forward feature from the first portion to the last portion of a time series array for N or more sequence vectors, and derive a reverse feature from the last portion to the first portion of the time series array for the N or more sequence vectors, so that sufficient features for time series data can be derived.

According to one embodiment of the present invention, some of the learned nodes of BLSTM for the first feature extraction unit and LSTM for the second feature extraction unit are deleted, so that overfitting to data output values can be prevented.

According to one embodiment of the present invention, the first feature extraction unit is composed of the BLSTM model other than the GRU model, so that the initial seed information can be predicted with higher accuracy compared to being composed of the GRU.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A pseudo-random number prediction system for predicting a pseudo-random initial seed, the pseudo-random number prediction system comprising:
a feature extraction module for receiving N sequence vectors (N is a natural number of 1 or more) for a pseudo-random number to extract a learning vector for each of the N sequence vectors containing feature information on the pseudo-random number; and
a prediction module for receiving the learning vector for each of the N sequence vectors extracted from the feature extraction module, to derive initial seed information on the pseudo-random number.

2. The pseudo-random number prediction system of claim 1, wherein the feature extraction module includes a first feature extraction unit and a second feature extraction unit, in which
the first feature extraction unit receives the N sequence vectors to extract a first learning vector containing first feature information for each of the N sequence vectors, and
the second feature extraction unit receives the first learning vector for each of the N sequence vectors extracted from the first feature extraction unit to extract a second learning vector containing second feature information for each of the N sequence vectors.

3. The pseudo-random number prediction system of claim 1, wherein the prediction module includes a full connection layer and a regression layer, in which
the full connection layer receives a learning vector for each of the N sequence vectors from the feature extraction module to output a result vector for each of the N sequence vectors, and
the regression layer receives the result vector for each of the N sequence vectors from the full connection layer to output initial seed information on the corresponding pseudo-random number.

4. The pseudo-random number prediction system of claim 2, wherein the first feature extraction unit uses the learned bidirectional long short-term memory (BLSTM) to extract a forward feature and a reverse feature for the N sequence vectors, and input the forward feature and the reverse feature into an activation function, thereby extracting a first learning vector containing first feature information for each of the N sequence vectors, and
the second feature extraction unit uses the learned LSTM to extract a second learning vector containing second feature information for each of the N sequence vectors.

5. The pseudo-random number prediction system of claim 4, wherein some preset number of learned nodes included in the learned BLSTM are removed to prevent overfitting,
some preset number of learned nodes included in the learned LSTM are removed to prevent overfitting,
the BLSTM includes:
a forward part including at least one LSTM; and
a reverse part including at least one LSTM, and
the N sequence vectors are input to the forward part and the reverse part, so as to be input in a forward direction according to a sequence of pseudo-random numbers to the at least one LSTM included in the forward part, and so as to be input in a reverse direction of the forward direction input to the forward part to the at least one LSTM included in the reverse part.
